(19) United States
(12) Patent Application Publication
(10) Pub. No.: US 2020/0290908 A1
(43) Pub. Date: Sep. 17, 2020

(54) SUBMERGED BIO-RESTORATION ARTIFICIAL ECOSYSTEM REACTOR

(71) Applicant: IMET CORPORATION, Cleveland, OH (US)

(72) Inventors: Mehmet A. GENCER, Breaksville, OH (US); Kaan GENCER, Brecksville, OH (US); Clark B. LANGMACK, Gates Mills, OH (US); Richard A. SCHWARZ, Akron, OH (US); Paul M. ZAKRISKI, Broadview Heights, OH (US)

(21) Appl. No.: 16/818,011

(22) Filed: Mar. 13, 2020

Related U.S. Application Data
(60) Provisional application No. 62/818,938, filed on Mar. 15, 2019.

(51) Int. Cl. C02F 3/34

(52) U.S. Cl. CPC C02F 3/348; C02F 2103/007

(57) ABSTRACT

An aerobic bio-restoration aqueous system is contained in an artificial ecosystem that treats contaminated water to yield a natural balance or state wherein indigenous flora, fauna, insects and animal life thrive. The system contains a reactor that has exterior walls for enclosing contaminated water. The walls can be solid, but generally contain one or more perforated areas. An important advantage of the present invention is that the perforated areas such as openings, holes, etc., allow the aqueous matter to flow into as well as out of the artificial ecosystem. The ecosystem reactor can be located in a lake, a pond, or other aqueous environments. Water can flow into the artificial ecosystem and be bio-remediated, by utilizing natural flow and/or currents of the aqueous ecosystem. Various types of one or more inert media substrates containing pores that generally contain one or more microorganisms therein serve to bio-remediate various matter contained in the aqueous system such as contaminated water, e.g. industrial contaminates, residential contaminates, commercial contaminates, sewage, or corrosive compounds, and the like as well as bio-sludge. Other matter that can be bio-remediated include algae, food wastes including dissolved sugar sources, fats, grease, oils, and also excrement from animals such as humans, cows, horses, pigs, chickens, and the like as well as various sulfur, nitrogen, phosphates, and carbon compounds. The inert media substrates are generally contained in a perforated bag or pipe. Optionally, an aerator can be utilized to supply air to the artificial ecosystem.

### FIELD OF THE INVENTION

The present invention relates to a water body bio-restoration ecosystem that shifts the natural balance and restores waterways to a state where indigenous flora, fauna, insects, and animal life thrive within the water body. An artificial ecosystem, for example an ecosystem reactor includes walls for enclosing an aqueous system such as waterways that comprises various types of contaminated waters therein. The walls can be solid, but must contain one or more perforated areas. An important advantage of the present invention is that the perforated areas allow the aqueous contaminated water to naturally flow into as well as out of the ecosystem reactor. The water body ecosystem reactor can be located in a lake, a pond, a reservoir, a river, a stream, a channel, or other aqueous environment. The availability of natural water flow or currents increases the efficiency for bio-restoration of an ecosystem. Various types of one or more inert media substrates containing pores that generally have one or more microorganisms therein serve to digest or bio-remediate various types of contaminated waters such as industrial, residential, commercial sewage, or corrosive compounds, and the like as well as bio-sludge, natural sources such as algae, residential waste including dissolved sugar sources, fats, grease, or oils, excrement from animals such as humans, cows, horses, pigs, chickens, and the like, also various sulfur, nitrogen, phosphates, or carbon compounds and even cyanide compounds. The substrates are generally contained in a perforated bag or a perforated pipe so that they are confined within the ecosystem reactor or they can be freely maintained therein.

### BACKGROUND OF THE INVENTION

Various process and/or devices have been utilized to treat the contaminated water including the following.

U.S. Pat. No. 4,810,385 relates to a device for seeding bacterial cultures to waste flowing through or which has accumulated in a collection system which comprises a porous outer covering member which forms an enclosed package with a source of bacterial cultures contained within said package, said cultures were utilized for seeding a collection system as a waste stream flows through the porous covering member of said enclosed package causing the bacteria to be released into said waste stream.

U.S. Pat. No. 4,859,594 relates to microorganisms separated from natural environments and purified and genetically modified, to a process for immobilizing microorganisms by affixing them to substrates, to the biocatalytic compositions formed by these microorganisms affixed to substrates, and the use of the biocatalytic compositions for the detoxification of toxin-polluted streams. The microorganisms are (1) Pseudomonas fluorescens (ATCC SD 904); (2) Pseudomonas fluorescens (ATCC SD 903); (3) Pseudomonas cepacia (ATCC SD 905); (4) Methylobacter rhodinum (ATCC 113-X); and (5) Methylobacter species (ATCC 16 138-X).

U.S. Pat. No. 4,882,066 relates to compositions characterized as porous solids on the surfaces of which thin films of chitinous material are dispersed, and to a process employing chitin per se, and preferably the chitin coated compositions, supra, as contact masses for the removal of metals contaminants, or halogenated organic compounds, from liquid streams contaminated or polluted with these materials.

U.S. Pat. No. 5,021,088 relates to a process for the separation and recovery from an ore of a metal, or metals, particularly strategic and precious metals, notably gold. A carbon-containing, gold-bearing ore, notably a carbonaceous or carbonaceous pyritic ore, is contacted and microbially pretreated and leached with a heterotrophic microorganism, or admixture of microoganisms, at heterotrophic conditions to cultivate and grow and said microorganism, or microorganisms, and reduce the carbon content of the ore by consumption of the carbon. The ore, as a result of the heterotrophic pretreatment is subsequently more advantageously colonized by an autotrophic microorganism, or microorganisms, at autotrophic conditions, or hydrometallurgically treated, or both, to facilitate, enhance and increase the amount of gold recovered vis-a-vis a process wherein the gold is recovered (1) by hydrometallurgical processing alone at otherwise similar conditions, or (2), in treating a pyritic ore, by the combination of the autotrophic/hydrometallurgical processing, at otherwise similar conditions.

U.S. Pat. No. 5,211,848 relates to a continuous flow, immobilized cell reactor, and bioprocess, for the detoxification and degradation of volatile toxic organic compounds. The reactor is closed, and provided with biocatalysts constituted of specific adapted microbial strains immobilized and attached to an inert porous packing, or carrier. A contaminated groundwater, industrial or municipal waste, which is to be treated, is diluted sufficiently to achieve biologically acceptable toxicant concentrations, nutrients are added, and the pH and temperature are adjusted. The contaminated liquid is introduced as an influent to the closed reactor which is partitioned into two sections, or compartments. Air is sparged into the influent to the first compartment to mix with and oxygenate the influent with minimal stripping out of the toxic organic compounds. The second section, or compartment, is packed with the biocatalyst. The oxygenated liquid influent is passed through the second compartment substantially in plug flow, the biocatalyst biodegrading and chemically changing the toxic component, thereby detoxifying the influent. Non-toxic gases, and excess air from the first compartment, if any, are removed through a condenser located in the overhead of the reactor. Liquids are recondensed back to the aqueous phase via the condenser.

U.S. Pat. No. 5,240,598 relates to a microbubble generator for optimizing the rate and amount of oxygen transfer to microbial inocula or biocatalysts in bioreactor systems. The microbubble generator, and an associated immobilized cell reactor, are used in the detoxification and cleanup of non-volatile polymeric and volatile organic-contaminated aqueous streams. In particular, they are useful in the continuous mineralization and biodegradation of toxic organic compounds, including volatile organic compounds, associated with industrial and municipal effluents, emissions, and ground water and other aqueous discharges. One embodiment of the invention includes a microbubble chamber packed with small inert particles through which a liquid effluent and oxygen or another gas are admitted under pressure, followed by a venturi chamber to further reduce the size of bubbles.

U.S. Pat. No. 5,403,487 relates to the biochemical oxidation of two wastewater feeds, one containing at least ten times more ammonia nitrogen, and the other at least ten times more chlorinated hydrocarbons, than present in a conventional municipal wastewater stream were treated in an aerated packed bed bioreactor inoculated with microorganisms (“cells”) especially cultured and acclimated to the task. Arbitrarily shaped pieces of numerous microporous synthetic resinous materials (familiarly referred to as “porous plastics”) supposedly provide not only a packing for the bioreactor, but also a peculiar catalytic function not normally associated with a bio-support.

U.S. Pat. No. 5,534,143 relates to a microbubble generator for optimizing the rate and amount of oxygen transfer to microbial inocula or biocatalysts in bioreactor systems. The microbubble generator, and an associated immobilized cell reactor, are useful in the detoxification and cleanup of non-volatile polymeric and volatile organic-contaminated aqueous streams. In particular, they are useful in the continuous mineralization and biodegradation of toxic organic compounds, including volatile organic compounds, associated with industrial and municipal effluents, emissions, and ground water and other aqueous discharges. One embodiment of the invention includes a microbubble chamber packed with small inert particles through which a liquid effluent and oxygen or another gas are admitted under pressure, followed by a venturi chamber to further reduce the size of bubbles.

U.S. Pat. No. 5,569,634 relates to porous bodies produced which are used as supports for catalysts, including living cells, such as bacteria and which are upset resistant to acids and bases. The bodies have a significantly large average pore diameter of about 0.5 to 100 microns, (i.e. 5,000 to 1,000,000 Å) and a total pore volume of about 0.1 to 1.5 cc/g with the large pores contributing a pore volume of from about 0.1 to 1.0 cc/g. The bodies are made by preparing a mixture of ultimate particles containing a zeolite and one or more optional ingredients such as inorganic binders, extrusion or forming aids, burnout agents, or a forming liquid, such as water.

U.S. Pat. No. 5,747,311 relates to a method for chemically modifying a reactant using microbes. The method includes providing a particulate material which includes a plastic carrier and microbes attached to the carrier. The particulate material is dispersed in a dispersing fluid and has a specific gravity less than that of the dispersing fluid. When the microbe is anaerobic the particulate material has an operating interfacial surface area of from about 2,000 to about 240,000 square meters per cubic meter of reactor volume. When the microbe is aerobic the particulate material has an operating interfacial surface area of from about 1,000 to about 30,000 square meters per cubic meter of reactor volume. The method further includes establishing a flow of the reactant through the particulate material effective to contact the reactant with the microbes for a time sufficient to chemically modify the reactant.

The article Carbon and Nitrogen Removal by Biomass Immobilized in Ceramic Carriers by I. Wojnowski-Baryla, et al., relates to an experiment conducted in a bioreactor with biomass immobilization in ceramic carriers. The influence of hydraulic retention time (HRT), carrier structure and intrinsic circulation rate on carbon and nitrogen removal from municipal wastewater were investigated. Two types of ceramic carriers were used at HRT 70, 60, 40, 30 min for carrier I, and 70, 60, 30, 15 min for carrier II, and at the circulation rate of 60, 40, and 20 dm.sup.3 h⁻¹. The highest nitrogen removal efficiency was achieved in carrier II at 30 min of reaction. The carbon removal efficiency was similar for both carriers. An increase in internal circulation rate from 20 to 60 dm.sup.3 h⁻¹ enhanced nitrogen removal efficiency from 33.0 to 47.2% and decreased in the production of surplus sludge in carrier II.

The article The Biodegradation of Brewery Wastes in a Two-Stage Immobilized System by I. Wojnowski-Baryla, et al, relates to the investigation in a loop bioreactor, where biomass was immobilized in the ceramic carrier. The influence of the internal circulation rate on the biodegradation efficiency of brewery wastes by immobilized biomass and on production of surplus sludge was examined. The rates of the internal circulation were 12, 38, 50 dm³ h⁻¹. The experiments were performed at constant loading rate of the carrier of 17.9 caused enhancement of the removal rate from 0.40 to 0.48 gCOD dm³ h⁻¹ and limitation of surplus sludge productivity from 0.67 to 0.27 g g⁻¹ COD removed. The biodegradation rate of brewery wastes in a two-stage immobilized system was determined. The hydraulic retention time in this two-stage immobilized system was 6 h, which was enough to get a COD below 150 mg dm⁻³ in the effluent.

### SUMMARY OF THE INVENTION

The present invention relates to an artificial bio-restoration ecosystem for an aqueous system containing contaminated water, comprising a submergible ecosystem reactor having exterior walls for enclosing said contaminated water, at least some of said walls having one or more perforated areas to allow said contaminated water to flow into and out of said ecosystem reactor perforated areas; said ecosystem reactor having one or more inert media substrates having micropores therein, said micropores having one or more microorganisms therein, said microorganisms being capable of treating said contaminated water, and wherein the ecosystem reactor desirably is free of any chimneys, free of any separators, and free of any tubes.

### BRIEF DESCRIPTION OF THE DRAWINGS

FIG. 1 is a perspective view of an in-situ bio-restoration ecosystem reactor of the present invention having a perforated top;

FIG. 2 is a perspective view of the same ecosystem reactor having a perforated bottom;

FIG. 3 is another perspective view of a bio-restoration ecosystem reactor of the present invention wherein perforated bags containing porous substrates therein have been added to one side of the ecosystem reactor;

FIG. 4 relates to an optional bio-restoration ecosystem reactor containing an aerator supply pipe system on the left-hand side connected to aerator pipes on the right-hand side of said ecosystem reactor;

FIG. 5 is a drawing of an aqueous body containing bio-restoration ecosystem reactors at different vertical locations;

FIG. 6 is a cross-sectional view of a tank or a body of water wherein the ecosystem reactor is located at the bottom thereof;

FIG. 7 is a cross-sectional view of a bio-remediation tank containing optional aerators at the bottom thereof and wherein the ecosystem reactors of the present invention are located above said aerators;

FIG. 8 is a cross-sectional view of pipe or bag containing porous substrates having microorganisms therein capable of bio-remediating contaminated water; and

FIG. 9 is a cross-sectional view of an ecosystem reactor of the present invention containing a perforated pipe or perforated bag, or both therein, as well as channels to increase the flow of contaminated water through said reactor.

### DETAILED DESCRIPTION OF THE INVENTION

The present invention relates to a bio-restoration artificial ecosystem reactor 10 having exterior walls that have one or more perforated areas therein such as holes, or apertures, and the like, that allows contaminated water to enter as well as to leave or exit the ecosystem reactor. The bio-restoration artificial ecosystem reactors can admit contaminated water 60 through one entrance and release treated contaminated water through other, or different exits, Also, the reactors can allow the contaminated water to enter as well as to exit or leave the ecosystem reactor in the exact same perforated wall areas 20 of the ecosystem reactor. The total amount of the perforated wall areas on any individual ecosystem reactor is generally from about 10% to about 90%, desirably from about 20% to about 80%, and preferably from about 30% to about 70% based upon the total exterior wall surface of said individual reactor. Such amounts are generally sufficient to permit a desired amount of waste water under flow through ecosystem reactor 10 to permit effective bioremediation of the waste water to restore a suitable indigenous aqueous environment.

The bio-restoration ecosystem reactors of the present invention are well suited to be utilized in aqueous environments that contain natural flow of contaminated water 60 or contaminated water currents such as is inherently found in a water body such as contaminated rivers, streams, brooks, and channels, or natural flow or current as generated by waves as in contaminated lakes, ponds, reservoirs, and the like, or naturally flow or currents as generated in contaminated (waste) water plants, sewage plants, and the like. For example, in sewage treatment plants or industrial treatment plants currents are created as by the subsequent addition of additional sewage, industrial waste, and the like. An important aspect of the present invention is that while they may be used, the bio-restoration ecosystem reactors do not require an auxiliary pump, etc., so that the use of any electricity, can be eliminated. Rather, the natural flow or currents of an aqueous environment are utilized, such as ebb and flow, waves, water flow as by a river, tides, etc.

Bio-restoration ecosystem reactor 10 can be made out of various different materials such as a metal, for example rust resistant steel or iron, copper, or aluminum, or any conventional plastic such as polyvinyl chloride, polyethylene, polypropylene, nylon, polyester, polyurethane, and the like. The reactor can even be made out of wood although the same is not desirable. A key aspect of the ecosystem reactor of the present invention is that it is heavier than water, i.e. specific gravity of greater than 1.0 such that it sinks. For example, from about 1.0 to about 2.0, and desirably from about 1.1 to about 1.5.

The bio-restoration ecosystems reactors 10 of the present invention have an exterior surface thereof that can be of any shape, size, and the like such as cubic, rectangular, spherical, rhombic, and the like. An important and essential aspect of such ecosystems reactors is that at any location thereon the exterior walls can have one or more perforated areas, e.g. openings and/or holes, etc. to admit contaminated water as well as to release treated water therefrom. The perforated areas can be of any shape or size such as circular, oval, elongated, square, etc.

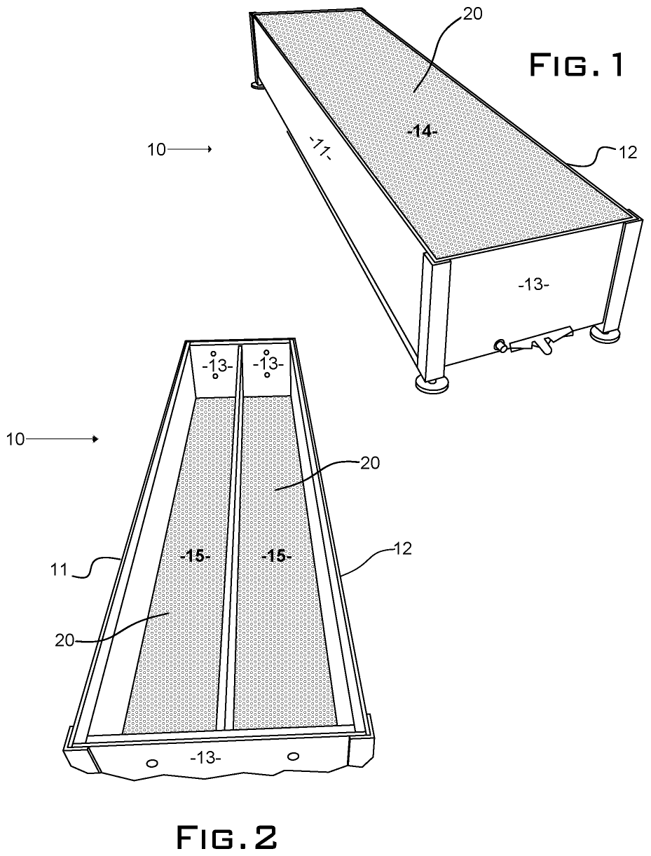

With respect to the various perforated areas 20, they can be made in metal, plastic sheets, and the like. Alternatively, they can be openings, apertures, etc. as in a screen, a wire mesh having openings between the wires, a metal or plastic panel having openings or apertures therein such as shown in FIGS. 1, 2, and 3, a woven sheet having very narrow openings, etc., between the adjacent strands, such as a woven fabric, for example nylon, polypropylene, polyethylene, or polyester, and the like. Such technology with respect to perforated areas is known to the art and to the literature.

The location of the perforated areas can be on any one or more portions of the ecosystem reactor. For example, in FIGS. 1 through 4 perforated areas 20 are generally contained throughout the entire bottom portions of the ecosystem reactor. The bio-restoration ecosystem reactor 10 of FIGS. 1 through 4, have a front side 11, a back side 12, and two end sides 13, and a top side 14, and bottom side 15 wherein only top and bottom sides 14 and 15 have perforations therein, that is openings or holes therein. However, as noted above, any side, or any area portion thereof can be perforated, wherein the one or more openings, and/or holes, etc., can be of any size, shape, or configuration, and the like. The size of the various openings or holes 20 can vary from very small to a large size provided that the hole, opening, etc., is smaller than packing substrates 30. Such openings and/or holes, etc., can be made in any conventional manner that is known to the literature and to the art. In summary, numerous combinations of contaminated water purification or treated routes can exist in the ecosystem reactor such as from an end side to any other side, or from a front side to any other side, etc., or from a bottom side to a top side, or from a front side to a back side, etc.

The path of the contaminated water is generally random, depending upon the natural current or flow of the contaminated water in the aqueous environment as noted, for example, a river, stream, lake, pond, and so forth. Utilizing the natural currents of the aqueous environment with the utilization of one or more such bio-restoration ecosystems reactors of the present invention, will bio-remediate the contaminated water such that it is substantially purified, treated, etc., and generally totally eliminates any contamination contained therein.

Another aspect of the present invention is that bio-restoration of an ecosystem of the present invention includes treating the contaminated water in any direction other than generally a vertical throughput of the contaminated water as set forth in heretofore prior art reactors. That is, instead of the contaminated water entering at the bottom of the vertical reactor and rising vertical (e.g. straight up) therethrough, the natural current can include an angle of the initial waste water entrance point to exit from the ecosystem reactor 10 of the present invention such that the initial treatment location to the final exit treatment location is other than about 90°. For example, it can be about 80° or less, desirably about 75° or less, more desirably about 70° or less, and even about 65° or less. Of course, all other treatment routes can be utilized as where the flow of the current is essentially horizontal, downward, generally about vertically downward (e.g. straight down), and the like.

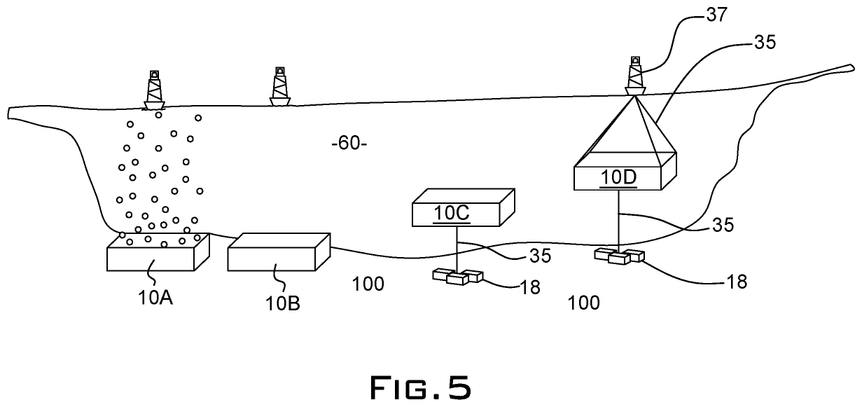

As shown in FIG. 5, a plurality of artificial ecosystem reactors 10 can be utilized to treat a pond, lake, etc., all without the use of any pump or equivalent device to admit the contaminated water into the bio-restoration ecosystem reactor 10. However, if needed, a current can be artificially created via use of an external pump (not shown) in a given waterbody but such is generally not necessary or desired. The ecosystem reactors can generally be located at any height or depth within the aqueous environment. For example, ecosystem reactors 10A and 10B can be located on the bottom of the aqueous environment such as a lake, pond, etc., as shown in FIG. 5. Alternatively, reactor 100 that has float or buoyant materials attached thereto (not shown) can be located at a desired height from the aqueous bottom surface, anchored 18, as by a chain or rope 35 such as shown in FIG. 5. The reactor height can vary from just above the bottom surface to a height wherein the top or upper most surface of the ecosystem reactor is approximately 6 to about 12 inches from the top of the contaminated water surface.

The method and apparatus according to the present invention eliminates industrial contaminates, residential contaminates, farm contaminates, commercial contaminates, sewage, corrosive compounds, and the like. Examples of industrial contaminates include carbonaceous compounds, odors, noxious compounds, toxic compounds, and compounds containing ammonia, ammonium, NO₂, NO₃, bio-sludge, as well as various sulfur or phosphorous compounds. Other industrial contaminates include hydrocarbons such as hexane, benzene, toluene, xylene, and the like, alcohols such as ethanol, methanol, phenol, and the like, nitrogen-containing chemicals such as ammonia, aniline, morpholine, and the like. Examples of residential contaminates include dissolved sugar sources, waste food, fats, grease and oil, and the like and dissolved proteins, starches, and of course human excrement. Examples of farm contaminates include excrement from animals, for example, cows, horses, pigs, chickens, turkeys, and the like. Examples of commercial contaminates include dissolved sugar sources, waste food, fats, grease and oil and the like and dissolved proteins, starches and the like, as well as waste from restaurants and food service operations that generally produce large amounts of fats, oils, and grease. Examples of sewage include human waste as well as from any industrial, residential, and commercial sources that are of course piped to a municipal treating plant. Examples of corrosive contaminates include sulfur-containing compounds such as H₂S, and the like, as well as carbonate-containing compounds such as lime and soda and the like, nitrogen-containing compounds such as vinegar, fertilizer, CN and the like, and chloride-containing compounds such as table salt and the like, and also various phosphorous containing compounds.

An important aspect of the present invention is the utilization of numerous inert media substrates or packing substrates 30 that desirably have large surface areas, and small pores therein such as micropores.

With regard to the surface area, substrates 30 have a high surface area, independently, such as from at least about 100 square meters per cubic meter (M²/M³) and desirably at least about 500 M²/M³ to about 1,000 M²/M³, 100,000 M²/M³ and even 200,000 M²/M³ where M² is the surface area and M³ is the volume. A more desirable range of the one or more high surface area packing substrates is from about 500 M²/M³ or 800 M²/M³ to about 10,000 M²/M³. Desirably a plurality of different types of inert media substrates are utilized.

Another important attribute is that substrates 30 be porous and have a number of pores therein. The average size of the pores are desirably small but sufficiently large enough to house one or more microorganisms including a colony of various microorganisms. The average pore size, independently, can vary over a wide range such as from at least about 1 micron to about 150 microns, or up to about 250 microns, and even up to about 500 microns. More desirable pore sizes range from about 4, or about 20, or about 30, or about 50 microns to about 75 microns or to about 100 microns. The pores desirably exist not only on the surface of the substrate, but also in the interior thereof and entirely there through such that the substrate often has an “open pore structure”.

The size of the porous inert media particles, e.g. average length, is from about 3 to about 15 millimeters, and desirably from about 5 to about 10 millimeters.

A desirable aspect of the present invention is that multiple microorganism, e.g. 2, 3, 4, 5, etc. be applied, attached, fixed, etc., to the inert media substrates. Such binding can occur in a number of ways, modes, or surface characteristics such as physically or physico-chemically. Physical attachment can occur by the substrate having a rough surface to help mechanically secure the microorganisms thereto. Physico-chemical attachment can occur through dipolar interaction of the microorganisms to a substrate such as Vanderwalls forces and the like, Physico-chemical attachment can also occur through a cation or an anion microorganism portion respectively with an anionic or a cationic portion of the substrate attachment, or also through polar or non-polar bonding. Similarly, ionic or non-ionic portions of the microorganism can be attached via ionic or non-ionic bonding. Silica (SiO₂) provides anionic surface characteristics while alumina (Al₂O₃) provides cationic surface characteristic. Ion exchange resins (cation, anion) can also be used to immobilize a variety of microorganisms utilizing anionic and cationic attractions. Similarly, hydrophobic portions of the microorganism can be attached to hydrophobic portion of the substrate or via a hydrophilic-hydrophilic alignment, etc. While polyethylene and Teflon provide hydrophobic surface characteristics, acrylic polymers provide hydrophilic surface characteristics. The above attachment of the microorganisms to the porous substrates is such that the microorganisms are maintained in place throughout the bio-restoration process.

Another desirable aspect of the present invention is that multiple and generally numerous different types of inert porous substrates are utilized within a single ecosystem reactor. Substrates generally include minerals, carbon substrates, ceramic, metal substrates, polymers or plastics, and the like. Examples of various minerals include clay, diatomaceous earth, fuller's earth, titanium dioxide, zirconium dioxide, chromium oxide, zinc oxide, magnesia, boric, boron nitride, celite, slag, and the like. Examples of carbon substrates include charcoal, coal, pyrolized wood or wood chips, activated carbon and the like. Ceramics are generally silicates, alumina, mullite, and include brick, tile, terra cotta, porcelain, glasses of all types such as sodium glass and boron glass, porcelain enamels, refractories such as alumina, silicone carbide, boron carbide, and the like. Metal substrates include iron, nickel, cobalt, zinc, aluminum, and the like.

Polymers or plastics constitute another class of porous packing substrates and include homopolymers, copolymers, graft copolymers, and the like such as polystyrene or copolymers of styrene and/or α-methyl styrene and acrylonitrile, copolymers of styrene/acrylonitrile (SAN), terpolymers of styrene, acrylonitrile and butadiene rubber (ABS), copolymers of styrene/acrylonitrile modified with acrylate elastomers (ASA), copolymers of styrene/acrylonitrile modified with ethylene/propylene/diene monomer (EPDM) rubber (ASE), and copolymers of styrene and maleic anhydride (SMA); polyolefins such as polyethylene and polypropylene and mixtures thereof; polyvinyl chloride (PVC), chlorinated polyvinyl chlorides (CPVC); polycarbonates (PC); thermoplastic polyesters (TPES) including polybutylene terephthalate (PBT), polyethylene terephthalate (PET), and aromatic polyesters; polyether-ester segmented copolymers, such as Hytrel® by DuPont Corp.; polyurethanes (PUR); miscible blends of polystyrenes and polyphenylene oxides (PPO) commercially available as Norel from General Electric Company; polyacetals (POM); polymers of acrylic acid, methacrylic acid, acrylic esters, and methacrylic esters; polyamide-imides; polyacrylonitriles; polyarylsulfones; polyester-carbonates; polyether-imides; polyether-ketones (PEK); polyether-ether-ketones (PEEK); polyalphaether ketones (PAEK); polyether sulfones; polyphenylene sulfides; polysulfones; nylons; anionic and cationic exchange resins, combinations of any of these polymers as well as recycled mixed plastics and the like.

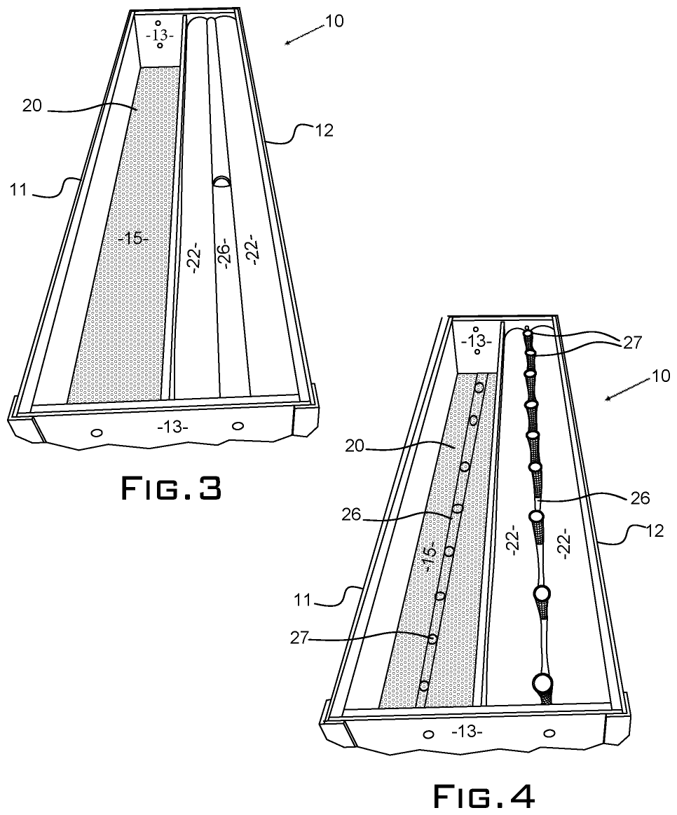

Inasmuch as the inert media substrates of the present invention will be contained in and confined within ecosystem reactor 10, the density or specific gravity thereof that is the weight in grams per one cubic centimeter, does not matter whether it is heavier than water or lighter than water. Generally, the density or specific gravity of the inert media substrates ranges from about 0.5 to about 2.0. If it floats a specific gravity thereof is generally from about 0.6 to about 0.95 or 0.98. If it sinks, the specific gravity thereof is from about 1.05 to about 1.8. The various inert media substrates can all float within the reactor, or all of them can have a specific gravity such that they sink therein, or one or more inert media substrates can float within the reactor while one or more other inert media substrates can sink within the reactor. Additionally, the one or more inert media substrates, regardless of whether any of them float, or any of them sink, or any mixture thereof, can be utilized in a container such as within a perforated bag 22, and/or a perforated pipe 23 that is made out of any desirable, generally water resistant, material such as plastic. Thus, the bags are desirably made of polyethylene, polypropylene, polyester, nylon, or PVC fabric. The bags can be generally any shape or size as long as they can fit into artificial ecosystem reactor 10. Thus, as shown in FIGS. 3 and 4, the bags 22 can extend the entire length of the ecosystem reactor, or various smaller bags, i.e. a plurality of bags, can be contained in the reactor 10 such as 2, 3, 5, 10, or more. The bags are made of a weave that is open so that polluted water as well as natural microbes can enter and egress therefrom. The bag perforations of course, are of a size that is smaller than the substrate particle size so that the inert substrates are retained, confined, or enclosed therein. The ecosystem reactor 10 volume filled by the one or more inert media substrates is generally from about 5 to about 98 vol. %, desirably from about 25 to about 85 vol. %, and preferably from about 30 to about 70 vol. % of the total interior volume of the ecosystem reactor.

With respect to the perforated pipes, said pipes 23 can be made out of polyethylene, high density polyethylene, polypropylene, polyester, poly vinylchloride nylon, polystyrene, and the like. Pipes 23 can be generally of any size, i.e. large or small, with the total interior volume being the same as set forth with respect to the one or more bags, i.e. from about 5 to about 98 volume percent, etc. Alternatively, the pipes can be used in combination with one or more bags as shown in FIG. 8. Plastic pipes 23 of course are perforated and thus contain opening, holes, apertures, and/or perforations 24 therein which of course are smaller than the smallest inert media substrates to prevent them from leaking out of pipes 23.

The microorganisms that are utilized in the bio-restoration and/or bio-remediation of the above wastes generally work through several different mechanisms such as aerobic, anaerobic, facultative, eradication, reaction therewith, formation of complexes, splitting of molecules, formation of new compounds such as carbon dioxide, water, sulfur dioxide, nitrites, nitrates, and nitrogen and the like. As noted above, preferably numerous and different types of microorganisms are utilized in the reactor so that a highly diverse microbial population exists to effectively treat most, and even all of the various types of the waste components found in the aqueous waste composition. Desirably, microorganisms are utilized that are found in nature such as in the soil, trees, ponds, lakes, streams, rivers, grains, plants, mold, spores, fungi, and the like. Microorganisms are generally defined as being cellular and being able to replicate without a host cell. One desired source of microorganisms are the various bacteria that are known to remediate various waste compositions. These different types of bacteria are numerous and known to the art and to the literature and thus include 1) bacteria to biodegrade carbonaceous compounds such as pseudomonas species such as Pseudomonas vesicularis, Pseudomonas putida and Aeromonas hydrophila, Brevibacterium acetylicum, 2) bacteria to biodegrade nitrogen-containing compounds such as Nitrobacter species such as Nitrobacter winogradskyi and Nitrosomonas species such as Nitrosomonas europaea, and 3) bacteria to biodegrade sulphur-containing compounds such as Thiobacillus species such as Thiobacillus denitrificans and the like. Other microorganisms include various fungi such as those that naturally exist in mushrooms, yeasts, and molds. Generally, they lack chlorophyll, have a cell wall composed of polysaccarides, sometimes polypeptides, and chitin, and reproduce either sexually or asexually. Protozoa can be utilized and they are simple microorganisms comprising unicellular organisms that range in size from sub-microscopic to macroscopic. Types of protozoa include sarcomastigophora, labyrinthomorpha, apicomplexa, microspora, acetospora, myxozoa, and ciliophora. Preferably at least two or three, and even four or more different types of microorganism exist within the reactors of the present invention inasmuch as the same have been found to destroy, disinfect, eradicate, eliminate, react with, etc., different various carbonaceous compounds, different various nitrogen containing compounds, different various sulfur containing compounds, different phosphorous containing compounds, different various toxic compounds, and the like.

A preferred embodiment of the present invention is that the ecosystem reactors 10 do not contain one or more aerators therein. That is, unlike the embodiment shown in FIGS. 3 and 4 wherein an aerator pipe 26 having outlets 27 therein is utilized, the ecosystem reactors are free thereof. That is, reliance is made upon the natural flow, ebb, current, tide, and the like of a water body. As noted above, the same results in a large economic advantage with regard to the use of additional required piping, air pumps, electrical sources, and the like.

An advantage of ecosystem reactors 10 of the present invention for the bio-restoration of an aqueous ecosystem is that there is no need to include any chimney therein. That is, ecosystem reactors 10 are free of any one or more chimney that generally receive air from outside the aqueous environment that is fed to the bottom of the chimney and pushed up through the chimney, generally containing openings therein, and exhaust the air through the top of the ecosystem reactor. Moreover, chimneys are difficult to install, require extensive plumbing, and are not needed to supply any air or oxygen to ecosystem reactor 10 of the present invention. Hence, chimney(s) within the artificial ecosystem are completely eliminated, that is they are completely free thereof.

The bio-restoration artificial ecosystems of the present invention are also completely free of any one or more bio-restoration solid tubes (i.e. non-perforated side areas) that generally extend in a vertical position from the bottom of a artificial ecosystem to a top thereof and generally contain one or more inert media substrates therein. In other words, the ecosystem reactors 10 of the present invention are free of any such tubes. The same greatly simplifies the use of the ecosystems of the present invention and another advantage is that no installation of the tubes is required, nor is any supply or amount of air to the bottom of the tube required with respect to the bio-restoration or the polluted water. The ecosystem reactors 10 of the present invention in being free of any chimney and also free of any side perforated tubes result in a large economic advantage with regard to the costs of preparing and maintaining such I ecosystem reactors.

Still another decided advantage is that the ecosystem reactors of the present invention have no need for a separator or a plurality of separators along the vertical height thereof so as to provide bio-remediation stages therein. That is, ecosystem reactors of the present invention are free of any one or more separators or stages therein. The lack of separators also eliminates the difficult task of installing and maintaining the same.

An alternative embodiment is that external aerators can be utilized in ecosystem reactors 10 of the present invention so that air, and more particularly oxygen, is contained within the aqueous environment and allow the various microorganisms to eradicate, digest, and otherwise bio-remediate or bio-restorate the contaminated matter in the polluted or contaminated water. Thus, in this embodiment of the invention, ecosystem reactors 10 can contain aerating systems utilizing conventional external aerators that obtain air, such as from above the aqueous environment, and pump the same down into aerator pipes 26. The pipe ends can be connected to an end side of the ecosystem reactor through conventional fittings, attachments, and the like. Whether reactors 10 are aerated, or preferably not aerated, they are fitted or deployed with one or more perforated bags 22, and/or perforated pipes 23, both of which contain porous packing substrates 30, a top side or cover 14 can be applied thereto in any conventional manner such as by screws, snap fittings, and the like.

The utilization of bio-restoration ecosystem reactors 10 of the present invention result in increased biological/microbial utilization of nutrients in the aqueous environment in which they are located, wherein natural flow or currents such as rivers, streams, brooks, or channels; or flow or currents generated by natural waves such as in lakes, ponds, or reservoirs, have a natural flow and/or waves, generally, therein such as in, waste collection ponds, sewage treatment plants, and the like. The same shifts the balance of utilization of the various nutrients and thus allows ecological internal growth of microbial and/or plant life, like coral in the ocean. In other words, growth of such items such as algae, blue-green algae, and other plant and microbial life forms will not have access to high levels of nutrients such as nitrogen NH₃, phosphorous compounds, and carbon sources that are generally detrimental to plant life. Rather, the ecosystems of the present invention generally reduce nitrogen-containing compounds to nitrogen N₂ and water, and reduce carbon containing compounds to carbon dioxide (CO₂) and so forth. Since the ecosystem reactors that can house a very large population of healthy, highly bio-diverse and natural mixture of microbial systems will continually utilize the available nutrients within waterbody. The level of nutrients can be controlled by the number of submerged ecosystem reactors or the total volume of various one or more inert media substrates placed within the aqueous ecosystem. As the level of nutrient concentrations within the waterbody are reduced to some safe, suitable, or harmless level then the dormant natural flora will start growing (flourishing). When this phenomenon happens, it represents the beginning of the restoring process of the waterbody. In other words, in the first phase, the concentration of nutrients will be brought down by the submerged ecosystem and in the second phase, natural growth within the waterbody will take over. This hybrid submerged ecosystem reactor-natural ecosystem will sustain the health of the water body.

Various embodiments of the ecosystem reactors of the present invention are set forth in FIGS. 1-10. FIGS. 1 and 2 show a typical ecosystem reactor 10 wherein top 14 and bottom 15 thereof have one or more perforated areas through which the contaminated water can flow into and out of. As noted above, the different walls, e.g. front side 11 and back side 12, ends 13, top 14, and bottom 15, etc., can totally or partially have perforated areas, for contaminated water 60 to enter and exit in any of a large number of different combination routes.

FIGS. 3 and 4 show an ecosystem reactor, such as set forth in FIGS. 1 and 2, that have perforated bags 22 therein which contain either partially, or totally one or more different types of porous packing substrates 30 that have micropores therein, independently, containing one or more different types of bacteria and/or bio-remediation material that serves to bio-remediate or purify the surrounding contaminated water 60 as contained within a tank, stream, channel, river, lake, pond, and the like. FIG. 3 also has an aeration pipe 26 operatively connected to an external air source (not shown) that supplies air to reactor 10 whereas FIG. 4 generally has the same set up but contains aeration pipe 26 in the left side of the reactor and also has multiple aeration outlets 27. As previously noted, the use of aerators is not desired in as much as natural flow or current of contaminated water is typically sufficient for bio-restoration of the treated ecosystem.

FIG. 5 relates to another embodiment of the present invention wherein multiple ecosystem reactors 10 are located with a contaminated body of water 60 such as a stream of river, pond, lake, and the like and are maintained at different elevations therein. For example, ecosystem reactors 10A and 10B are generally located on bottom 100 of the water body, whereas, ecosystem reactors 10C and 10D, respectively, by the use of floats (not shown), and/or by suspension from buoys 37 via rope and/or chain 35, exist at an elevated level in the aqueous environment. Thus, it is shown that the invention is very versatile with regard to the number and/or deployment of several reactors therein.

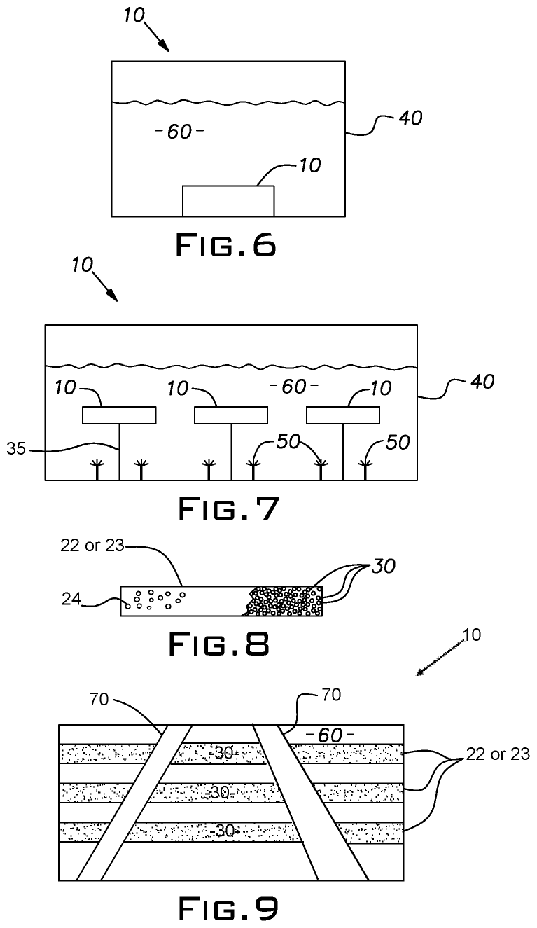

FIG. 6 is similar to FIG. 5 and shows ecosystem reactor 10 submerged within and resting on the bottom contaminated water environment 60. FIG. 7 is similar except that is contains a plurality of ecosystem reactors 10, secured to tank or water body via ropes or chains 35, that are anchored at the tank bottom in any conventional manner. The reactors float within contaminated water tank 40 since they have conventional floats attached thereto and the tank optionally has auxiliary aerators 50 therein to supply additional air containing oxygen to the reactors to increase the bio-remediation of the contaminated water 60 within tank 40.

FIG. 8 is a view of either a perforated bag 22 or perforated pipe 23 that contains numerous porous packing substrates 30 therein. Preferably, as noted above, the micropores of the packing contain different types of bio-remediation compounds, e.g. bacteria, therein to substantially and completely bio-remediate the various compounds that are contained within contaminated water 60.

FIG. 9 is a cross-section of ecosystem reactor 10 that can contain either perforated bags 22, or perforated pipes 23, or both, that contain packing substrates 30 therein. In order to aid the flow of natural current of a body water in which reactor 10 is contained, perforated enhancement (hollow) pipes 70 can be utilized that aid in assisting the natural flow of the contaminated water body through reactor 10 to obtain additional mixing, and increase the bio-remediation rate of the waste. Enhancement pipes 70 can generally be of the same continuous diameter, or be tapered as shown in the right hand embodiment of FIG. 10 to promote further mixing, agitation, and the like.

While in accordance with the patent statutes, the best mode and preferred embodiment have been set forth, the scope of the invention is not limited thereto, but rather by the scope of the attached claims.

What is claimed is:

1. A bio-restoration ecosystem, comprising:
a submergible ecosystem reactor having one or more exterior walls that are capable of enclosing contaminated water, said contaminated water having a natural flow or a current; said one or more exterior walls being perforated and being capable of permitting said natural flow or current of said contaminated water to flow therethrough;
said ecosystem reactor having enclosing submerged inert media substrates that have one or more micropores therein and, independently, have one or more bioremediation microorganisms in said one or more micropores; and
said ecosystem reactor being free of any separator, said ecosystem reactor being free of any reactor tube, and said ecosystem reactor being free of any chimney.

2. The bio-restoration ecosystem of claim 1, wherein said perforated exterior wall surface area of said reactor is from about 10% to about 90% of the total ecosystem reactor exterior surface area, and wherein the volume of said inert media substrates is from about 5% to about 98% based upon the total interior volume of said reactor.

3. The bio-restoration ecosystem of claim 2, wherein said volume of said inert media substrates is from about 25% to about 85%, wherein said perforated exterior wall surface area of said reactor is from about 20% to about 80%, wherein the size of said perforations is smaller than the size of said inert media substrates, and wherein said reactor is free of any aerator.

4. The bio-restoration ecosystem of claim 3, wherein the average pore size of said inert media substrates is from about 1 to about 500 microns, and wherein the surface area of said inert media substrates, independently, is from about 100 to about 200,000 M²/M³.

5. The bio-restoration ecosystem of claim 4, wherein the average pore size of said inert media substrates is from about 4 to about 250 microns.

6. The bio-restoration ecosystem of claim 5, wherein the average pore size of said inert media substrates is from about 30 to about 75 microns, and wherein the surface area of said inert media substrates, independently, is from about 500 to about 100,000 M²/M³.

7. The bio-restoration ecosystem of claim 3, wherein said ecosystem reactor is capable of being located from the bottom surface of a water body to an upper location wherein the top of said ecosystem reactor is approximately 12 inches below the water body surface.

8. The bio-restoration ecosystem of claim 7, wherein said one or more inert media substrates, independently, are located within a perforated bag, or a pipe having perforations therein, or are located freely within said ecosystem reactor, wherein said volume of said inert media substrates is from about 30% to about 70%, and wherein the size of said perforations is smaller than the size of said inert media substrates.

9. The bio-restoration ecosystem of claim 6, wherein said surface area of said inert media substrates, independently, is from about 800 to about 10,000 M²/M³; and wherein said perforated exterior wall surface area is from about 30% to about 70%.

10. The bio-restoration ecosystem of claim 5, wherein said microorganisms comprise a pseudomonas species comprising Pseudomonas vesicularis, Pseudomonas putida, Aeromonas hydrophila, Brevibacterium acetylicum; a Nitrobacter species comprising Nitrobacter winogradskyi; a Nitrosomonas species comprising Nitrosomonas europaea; a sulfur containing compound comprising Thiobacillus species or Thiobacillus denitrificans; a fungi that naturally exists in mushrooms, yeasts, and molds; or a protozoa comprising sarcomastigophora, labyrinthomorpha, apicomplexa, microspora, acetospora, myxozoa, and ciliophoran; or any combination thereof.

11. A process for the bio-remediation of contaminated water, comprising the steps of:
locating a submergible ecosystem reactor in contaminated water, said ecosystem reactor comprising one or more exterior walls that are capable of enclosing said contaminated water, said one or more exterior walls being perforated, said contaminated water having a natural flow or current, said perforated walls being capable of permitting said natural flow or current of said water to flow therethrough;
said ecosystem reactor having one or more inert media substrates therein, said inert media substrates having one or more micropores therein, said substrates, independently, having one or more bio-remediation microorganisms in said one or more micropores, said microorganisms capable of bio-remediating said contaminated water; and
said ecosystem reactor being free of any tube, free of any separator, and free of any chimney.

12. The process of claim 11, including bio-remediating said waste water in said reactor.

13. The process of claim 12, wherein said perforated exterior wall surface area of said reactor is from about 10% to about 90% of the total ecosystem reactor exterior surface area, and wherein the volume of said inert media substrates is from about 5% to about 98% based upon the total interior volume of said reactor.

14. The process of claim 13, wherein said volume of said inert media substrates is from about 25% to about 85%, wherein said perforated exterior wall surface area of said reactor is from about 20% to about 80%, wherein the size of said perforations is smaller than the size of said inert media substrates, and wherein said reactor is free of any aerator.

15. The process of claim 14, wherein the average pore size of said inert media substrates is from about 1 to about 500 microns, and wherein the surface area of said inert media substrates, independently, is from about 100 to about 200,000 M²/M³.

16. The process of claim 15, wherein the average pore size of said inert media substrates is from about 4 to about 250 microns.

17. The process of claim 16, wherein the average pore size of said inert media substrates is from about 30 to about 75 microns, and wherein the surface area of said inert media substrates, independently, is from about 500 to about 100,000 M²/M³.

18. The process of claim 17, wherein said one or more inert media substrates, independently, are located within a perforated bag, or a pipe having perforations therein, or are located freely within said ecosystem reactor, wherein said volume of said inert media substrates is from about 30% to about 70%, and wherein the size of said perforations is smaller than the size of said inert media substrates.

19. The process of claim 18, wherein said surface area of said inert media substrates, independently, is from about 800 to about 10,000 M²/M³; and wherein said perforated exterior wall surface area is from about 30% to about 70%.

20. The process of claim 9, wherein said microorganisms comprise a pseudomonas species comprising Pseudomonas vesicularis, Pseudomonas putida, Aeromonas hydrophila, Brevibacterium acetylicum; a Nitrobacter species comprising Nitrobacter winogradskyi; a Nitrosomonas species comprising Nitrosomonas europaea; a sulfur containing compound comprising Thiobacillus species or Thiobacillus denitrificans; a fungi that naturally exists in mushrooms, yeasts, and molds; or a protozoa comprising sarcomastigophora, labyrinthomorpha, apicomplexa, microspora, acetospora, myxozoa, and ciliophoran; or any combination thereof.
